(19) United States
(12) Patent Application Publication
(10) Pub. No.: US 2015/0017526 A1
(43) Pub. Date: Jan. 15, 2015

(54) SULFUR-CONTAINING COMPOSITE FOR LITHIUM-SULFUR BATTERY, THE ELECTRODE MATERIAL AND LITHIUM-SULFUR BATTERY COMPRISING SAID COMPOSITE

(71) Applicants: Roger Zhou, Shanghai (CN); Sen Xin, Shanghai (CN); Yuguo Guo, Shanghai (CN); NaHong Zhao, Shanghai (CN)

(72) Inventors: Roger Zhou, Shanghai (CN); Sen Xin, Shanghai (CN); Yuguo Guo, Shanghai (CN); NaHong Zhao, Shanghai (CN)

(73) Assignees: Robert Bosch GmbH, Stuttgart (DE); Institute of Chemistry, Chinese Academy of Sciences, Beijing (CN)

(21) Appl. No.: 14/379,009

(22) PCT Filed: Feb. 16, 2012
(86) PCT No.: PCT/CN2012/071215

§ 371 Date: Sep. 17, 2014

(51) Int. Cl. H01M 4/36; H01M 4/136; H01M 4/62; H01M 4/38

(52) U.S. Cl. CPC H01M 4/366; H01M 4/38; H01M 4/136; H01M 4/62
USPC 429/212; 429/218.1

(57) ABSTRACT

The present invention relates to a sulfur-containing composite, comprising a conductive microporous substrate and sulfur with chain structure loaded into said conductive microporous substrate; as well as an electrode material and a lithium-sulfur battery comprising said sulfur-containing composite.

### BACKGROUND OF THE INVENTION

The present invention relates to a sulfur-containing composite, comprising a conductive microporous substrate and sulfur with chain structure loaded into said conductive microporous substrate; as well as an electrode material and a lithium-sulfur battery comprising said sulfur-containing composite.

Lithium-sulfur (Li/S) batteries have a theoretical capacity nearly one magnitude higher than that of LiFePO₄. Nevertheless, the Li/S system has not yet been implemented in many applications because the following problems still need to be solved before sulfur cathode materials can be practically used in rechargeable lithium batteries: 1) particle size of sulfur should be made as fine as possible to ensure a high utilization rate of sulfur and then a high reversible capacity upon cycling; 2) discharge products of poly-sulfides should be carefully restrained from dissolving into electrolyte to ensure long cycle life; and 3) conductivity of the cathode material should be enhanced to ensure a better rate performance.

It is known that S₈ ring structure is a thermodynamic stable form of sulfur at STP. Under normal conditions, sulfur atoms tend to form S₈ ring-like molecules, the most stable existence form of sulfur. Most frequently quoted explanation is the low-lying unoccupied 3d orbits of sulfur which cause the pronounced tendency for catenation and the cross-ring resonance. A conventional Li—S battery based on cyclo-S₈ molecules usually discharges according to the two-electron reaction 1/8S₈+2Li⁺+2e ⇄Li₂S, which brings about two plateaus (FIG. 1). On the first plateau (at around 2.35 V), sulfur is reduced from cyclo-S₈ to S₄²⁻, during which a series of electrolyte-soluble polysulfides (such as Li₂S₈, Li₂S₆, and Li₂S₄) may form. On the other hand, the second plateau (normally starts from 2.0 V) corresponds to the transformation from Li₂S₄ to insoluble Li₂S₂ and finally Li₂S. Since the polysulfides generated in the discharge process may be dissolved into the electrolyte and then deposited onto the lithium anode during the charge process, the sulfur cathode may suffer from a severe capacity fade. Considering sulfur has many allotropes, for example, small sulfur molecules S₂₋₄ with short chain structures, S₅₋₂₀ with ring structures or chain structures, and polymeric sulfur S_{∞} with long chain structure, these allotropes may exhibit different electrochemical behaviors. However, there has been no report on the electrochemical behaviors of sulfur allotropes due to the unsteady existence of these allotropes under normal state.

It is known that most sulfur allotropes except for cyclo-S₈, especially the sulfur allotropes with chain structures can not steadily exist in normal conditions, thus making their preparation a great challenge.

SUMMARY OF INVENTION

It is therefore an object of the present invention to provide a high-energy-density Li—S battery with improved electrochemical performance, which makes it possible to solve the above problems.

This object is achieved by a sulfur-containing composite, comprising a conductive microporous substrate and sulfur with chain structure loaded into said conductive microporous substrate. Due to the confinement effect of micropores, sulfur molecules with chain structures can steadily exist in the microporous channel, and sulfur-containing composite thus produced can exhibit only one plateau.

According to another aspect of the invention, an electrode material is provided, which comprises the sulfur-containing composite according to the present invention.

According to another aspect of the invention, a lithium-sulfur battery is provided, which comprises the sulfur-containing composite according to the present invention.

### BRIEF DESCRIPTION OF DRAWINGS

The above-mentioned and other features and advantages of this invention, and the manner of attaining them, will become more apparent and the invention itself will be better understood by reference to the following description of embodiments of the invention taken in conjunction with the accompanying drawings, wherein:

FIG. 1 is a plot showing the discharge-charge curve of a S₈-carbon composite;

FIG. 2 is a Scanning Electron Microscopy (SEM) image of the carbon-carbon composite substrate (CNT@MPC) according to the present invention;

FIG. 2A is a schematic diagram of the carbon-carbon composite substrate (CNT@MPC) according to the present invention;

FIG. 3 is a Transmission Electron Microscopy (TEM) image of the carbon-carbon composite nanowire (CNT@MPC) according to the present invention showing its microstructure;

FIG. 3A is a schematic diagram of the carbon-carbon composite nanowire (CNT@MPC) according to the present invention showing its microstructure;

FIG. 4 is an Annular Bright-Field Scanning Transmission Electron Microscopic (ABF-STEM) image showing the carbon channels in the coating layer, in which the black part represents the carbon wall; while the light gray part represents the carbon channel;

FIG. 4A is a schematic diagram of the carbon channels in the coating layer;

FIG. 5 is a TEM image of the sulfur-containing composite prepared from the carbon-carbon composite substrate (CNT@MPC) according to the present invention (S %=33 wt %);

FIG. 5A is a schematic diagram of the sulfur-containing composite prepared from the carbon-carbon composite substrate (CNT@MPC) according to the present invention;

FIG. 6 is the elemental mapping of the sulfur-containing composite according to the present invention (S %=33 wt %);

FIG. 7 is an ABF-STEM image of the microporous carbon (MPC) layer after the load of sulfur, in which gray part represents carbon, black part represents sulfur, sulfur chains (black chains) can be clearly seen in the picture, and some of sulfur chains are marked with arrows;

FIG. 7A is a schematic diagram of discharge-charge procedure in the carbon channels;

FIG. 8 is a plot showing the discharge-charge curves of the sulfur-containing composite according to the present invention (S %=33 wt %) at a discharge-charge rate of 0.1 C;

FIG. 9 is a plot showing the cycling performance of the sulfur-containing composite according to the present invention (S %=33 wt %) at a discharge-charge rate of 0.1 C;

FIG. 10 is a plot showing the cycling performances of the sulfur-containing composite according to the present invention (S %=33 wt %) at different discharge-charge rates;

FIG. 11 is a Scanning Electron Microscopy (SEM) image of the polystyrene (PS) nanospheres according to the present invention;

FIG. 11A is a schematic diagram of the polystyrene (PS) nanospheres according to the present invention;

FIG. 12 is a Scanning Electron Microscopy (SEM) image of the sulfonated polystyrene (SPS) nanospheres according to the present invention;

FIG. 12A is a schematic diagram of the sulfonated polystyrene (SPS) nanospheres according to the present invention;

FIG. 13 is a Scanning Electron Microscopy (SEM) image of the carbon-coated sulfonated polystyrene (SPS@C) nanospheres according to the present invention;

FIG. 13A is a schematic diagram of the carbon-coated sulfonated polystyrene (SPS@C) nanospheres according to the present invention;

FIG. 14 is a Scanning Electron Microscopy (SEM) image of the microporous carbon sphere (MPCS) substrate according to the present invention;

FIG. 14A is a schematic diagram of the microporous carbon sphere (MPCS) substrate according to the present invention;

FIG. 15 is a Scanning Electron Microscopy (SEM) image of the sulfur-containing composite according to the present invention (sulfur content: 50.23 wt %);

FIG. 15A is a schematic diagram of the sulfur-containing composite according to the present invention;

FIG. 16 is a Transmission Electron Microscopy (TEM) image of the sulfur-containing composite according to the present invention (sulfur content: 50.23 wt %);

FIG. 16A is a schematic diagram of the sulfur-containing composite according to the present invention;

FIG. 17 is the elemental mapping of the sulfur-containing composite according to the present invention (sulfur content: 50.23 wt %);

FIG. 18 is an ABF-STEM image of the microporous carbon (MPC) layer after the load of sulfur, in which gray part represents carbon, black part represents sulfur, sulfur chains (black chains) can be clearly seen in the picture, and some of sulfur chains are marked with ellipses;

FIG. 19 is a plot showing the charge-discharge curves of the sulfur-containing composite according to the present invention (sulfur content: 50.23 wt %) in different cycles at a discharge-charge rate of 0.1 C; and

FIG. 20 is a plot showing the cycling performance of the sulfur-containing composite according to the present invention (sulfur content: 50.23 wt %) at a discharge-charge rate of 0.1 C.

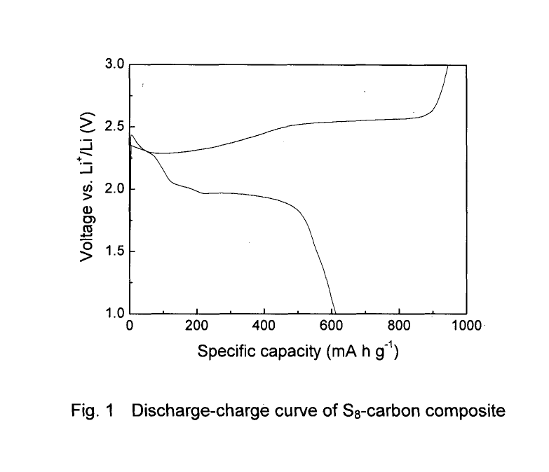

### DETAILED DESCRIPTION

The present invention relates to a sulfur-containing composite, comprising a conductive microporous substrate and sulfur with chain structure loaded into said conductive microporous substrate.

In the sulfur-containing composite according to the present invention, the conductive microporous substrate has a BET specific surface area of 300-4500 m²/g, preferably 400-1000 m²/g, more preferably 550-800 m²/g; a pore volume of 0.1-3.0 cm³/g, preferably 1.2-3.0 cm³/g, more preferably 1.3-2.0 cm³/g; and an average pore diameter of 0.2-1.0 nm, preferably 0.5-0.7 nm. Such microporous structure can confine sulfur molecules with chain structures, enhance the utilization of sulfur, and also helps to limit the dissolution of polysulfides into electrolytes, and thus improves the cyclic stability of sulfur.

These sulfur-containing composites can capture sulfur with chain structure, including small sulfur molecules S₂₋₄ with short chain structures, S₅₋₂₀ with chain structures, and polymeric sulfur S_{∞} with long chain structure, the diameter of which are less than the pore diameter of the microporous substrate.

In the sulfur-containing composite according to the present invention, sulfur is finely dispersed in the conductive microporous substrate, and in particular, loaded in the microporous channel formed by micropores of the conductive microporous substrate, which ensures a strong confinement effect of sulfur, a high electrochemical activity and utilization of sulfur.

The sulfur-containing composite according to the present invention has a sulfur content of 20-85 wt %, preferably 25-80 wt %, more preferably 30-75 wt %, most preferably 33-60 wt %, in each case based on the total weight of the sulfur-containing composite.

In the sulfur-containing composite according to the present invention, the conductive microporous substrate can be selected from the group consisting of carbon-based substrates, non-carbon substrates, and combinations or composites of carbon-based substrates and non-carbon substrates.

The non-carbon substrates are preferably selected from the group consisting of microporous conductive polymers, microporous metal, microporous semiconductive ceramic, microporous coordination polymers, microporous metal-organic frameworks (MOFs), and non-carbon molecular sieves, and combinations, composites, derivatives thereof.

The carbon-based substrates are preferably made of the carbon materials selected from the group consisting of carbon molecular sieve, carbon tube, microporous graphene, graphdiyne, amorphous carbon, hard carbon, soft carbon, graphitized carbon, and combinations, composites, derivatives, doped systems thereof

The carbon-based substrate can be, for example, a carbon-carbon composite substrate (CNT@MPC), wherein said carbon-carbon composite substrate (CNT@MPC) is formed by carbon nanotubes (CNTs) and a microporous carbon (MPC) coating layer applied onto the surface of the carbon nanotubes (CNTs).

In the carbon-carbon composite substrate (CNT@MPC), the microporous carbon (MPC) coating layer has a thickness of 30-150 nm, preferably about 40 nm, 60 nm, 80 nm, 100 nm, 120 nm, 130 nm, or 140 nm.

The carbon nanotubes (CNTs) which can be used in the carbon-carbon composite substrate (CNT@MPC) have a diameter of 2-100 nm, preferably about 10 nm, 30 nm, 40 nm, 60 nm, or 80 nm. The length of the carbon nanotubes (CNTs) used here is not particularly limited, for example less than 5 μm, 5-15 μm, or more than 15 μm.

There is no limit to the specific form of the carbon nanotubes (CNTs) used here. Single-walled carbon nanotubes (SWNTs), double-walled carbon nanotubes (DWNTs) and multi-walled carbon nanotubes (MWNTs) are usable, but multi-walled carbon nanotubes (MWNTs) are preferred.

The carbon-carbon composite substrate (CNT@MPC) preferably has a coaxial cable-like structure.

The carbon-based substrate can also be, for example, a microporous carbon sphere (MPCS) substrate, wherein the microporous carbon sphere (MPCS) substrate preferably has a diameter of 200-800 nm, preferably 300-600 nm, and the microporous carbon sphere (MPCS) substrate preferably has a hollow sphere structure.

The present invention further relates to an electrode material, which comprises the sulfur-containing composite according to the present invention.

The present invention further relates to a lithium-sulfur battery, which comprises the sulfur-containing composite according to the present invention.

It has been found by the inventors of the present invention that microporous structures according to the present invention have a strong confinement effect on the existence form of sulfur. Through constructing microporous structures with suitable pore sizes, sulfur molecules with chain structures can steadily exist in the microporous channel due to the confinement effect of micropores. The Li-S battery based on confined sulfur with chain structure has exhibited an entirely different discharge-charge characteristic (single discharge/charge plateau at around 1.9 V) with a high capacity and an excellent cycling stability. Besides, in practical applications, one plateau may be more convenient for the battery design than conventional sulfur cathode materials with two plateaus, all these brings great advantages to the utilization of Li—S batteries.

Moreover, the conductive microporous substrate according to the present invention has both favorable electric conductivity and relatively smaller pore diameter, thus is very promising in use as the substrate material for sulfur to form the sulfur-containing composite for Li—S battery. On the one hand, higher electric conductivity can help to reduce the polarization, hence improving the sulfur utilization ratio and then the cycling capacity. On the other hand, smaller pore diameter can help to disperse sulfur into nanoscale and limit the dissolution of polysulfides into the electrolyte, hence bettering the cycling stability of Li—S battery. Moreover, the preparation procedure is simple to implement, and all raw materials are low in price, all these merits make the composite very promising for Li—S batteries.

Potential applications of the composite according to the present invention include high-energy-density lithium ion batteries with acceptable high power density for energy storage applications, such as power tools, photovoltaic cells and electric vehicles.

The following non-limiting examples illustrate various features and characteristics of the present invention, which is not to be construed as limited thereto.

### EXAMPLE A

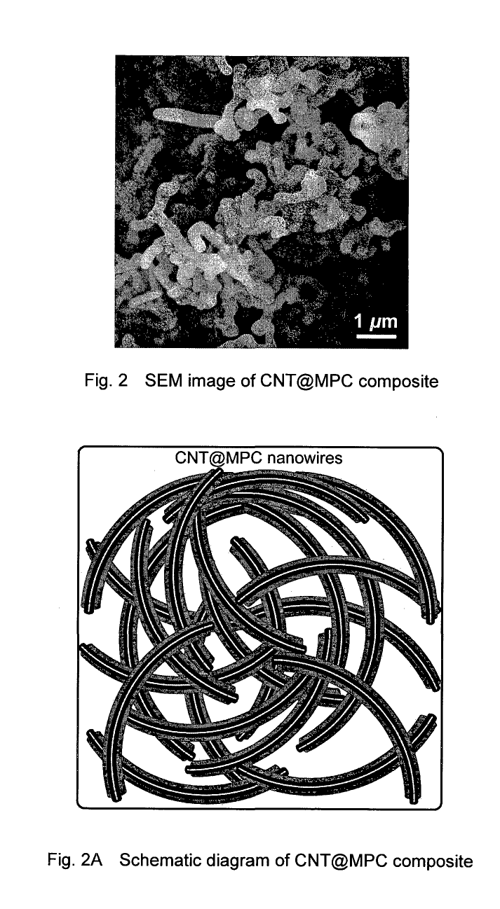

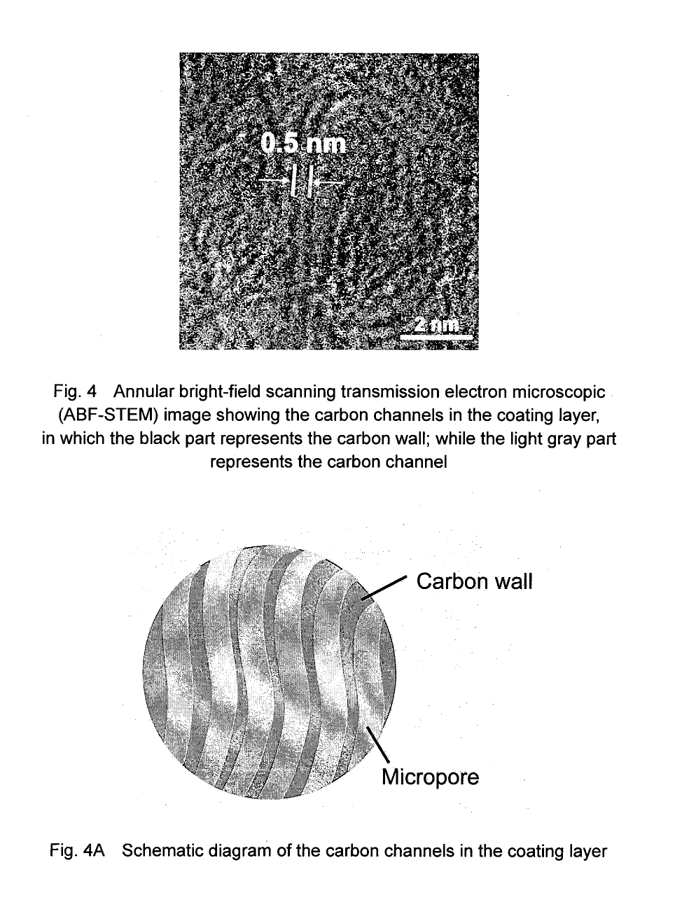

As the starting material, 30 mg of multi-walled carbon nanotubes (L.MWNTs-4060, Shenzhen Nanotech Port Co., Ltd., a purity of >95%, 40-60 nm in diameter, 5-15 μm in length) were firstly pretreated by 100 mL of 6 M dilute nitric acid for 12 h, and then were dispersed by ultrasound in 10 mL of sodium dodecyl sulfate (SDS, AR grade, purchased from Sinopharm Chemical Reagent Co., Ltd.) aqueous solution (1×10⁻³ M) at 40° C. to form a black suspension. After that, 1 g of D-glucose (AR grade, Sinopharm Chemical Reagent Co., Ltd.) was added into the suspension. The suspension was sealed in an autoclave and heated at 160° C. for 20 h to form the microporous carbon composite (CNT@MPC). After being washed with de-ionized water and dried in an oven at 50° C. overnight, said CNT@MPC composite was further annealed at 800° C. in argon for 4 h with a heating rate of 3° C./min to further carbonize the carbon coating layer. As-obtained CNT@MPC composite showed a diameter of 220-300 nm (thickness of carbon coating layer: 80-100 nm as shown in FIGS. 2-4), a specific surface area of 1025 m²/g, a total pore volume of 1.32 cm³/g, and an average pore diameter of 0.5 nm (FIG. 4).

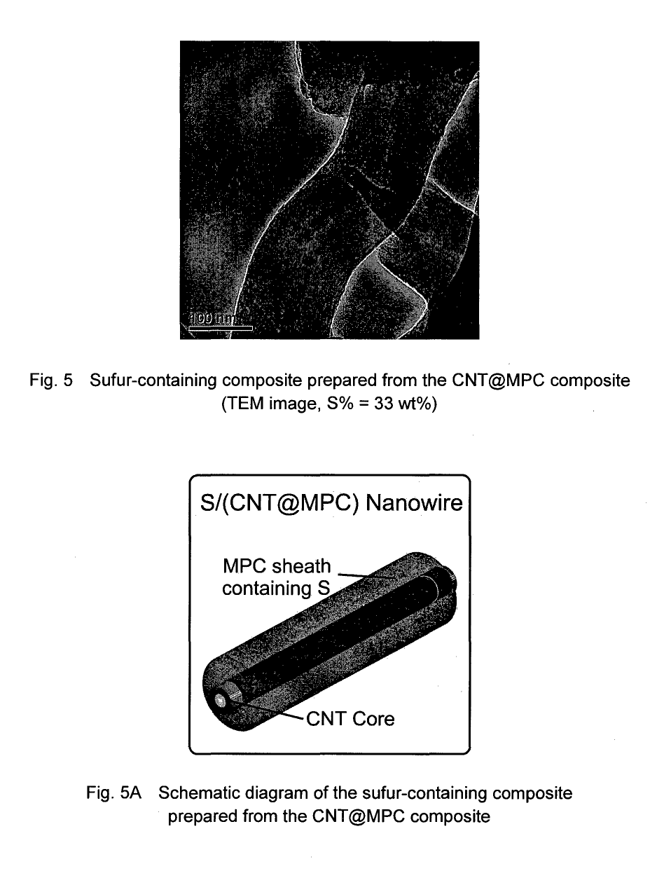

In order to prepare the sulfur-containing composite, sulfur powder (Aldrich, a purity of >99.995%) was firstly mixed with the CNT@MPC composite by a mass ratio of 1:2, then the mixture was sealed in a glass container and heated at 145° C. for 6 h to obtain the sulfur-containing composite with a sulfur content of 33% (FIGS. 5-7). After heating, the composite was naturally cooled down to room temperature to yield a black powder-like final product.

Scanning Electron Microscopy (SEM), Transmission Electron Microscopy (TEM), High-resolution Transmission Electron Microscopy (HRTEM), Annular Bright-field Scanning Transmission Electron Microscopy (ABF-STEM) and Energy Dispersive X-ray elemental mapping were employed to characterize sizes, structures, and elemental compositions of the products. The surface area of the composite was measured by a Brunauer-Emmett Teller (BET) nitrogen absorption and desorption method, which was carried out at 77.3 K on a Nova 2000e surface area pore size analyzer.

Electrochemical measurements were performed with coin cells assembled in an argon-filled glovebox. For preparing working electrodes, a mixture of active material, carbon black, and poly-(vinyl difluoride) (PVDF) at a weight ratio of 70:20:10 was pasted on an Aluminum foil. Lithium foil was used as the counter electrode. A glass fiber sheet (GF/D, Whatman) was used as a separator. An electrolyte (LB-301, Zhangjiagang Guotai-Huarong New Chemical Materials Co., Ltd.) consisting of a solution of 1 M LiPF₆ salt in ethylene carbonate (EC)/dimethyl carbonate (DMC) (1:1 W/W) was used. Galvanostatic cycling of the assembled cells was carried out using a battery testing system in the voltage range of 1-3 V (vs Li⁺/Li). All measured specific capacities are based on the mass of pure sulfur in the electrodes.

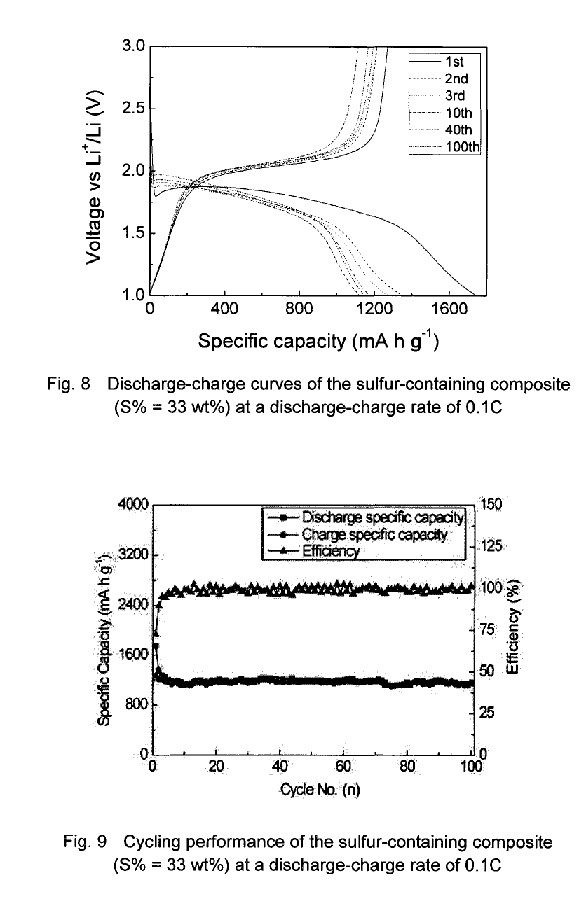

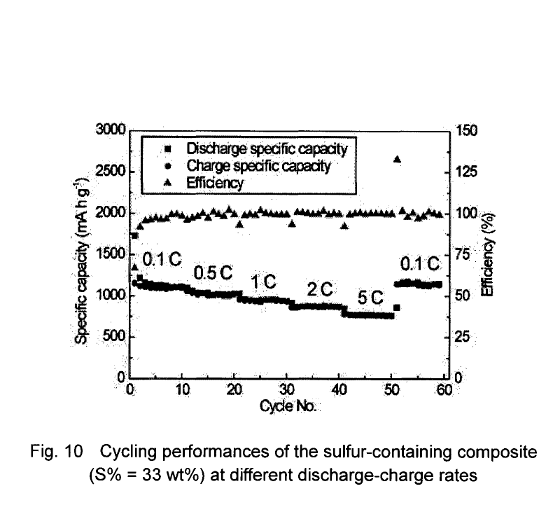

When discharged at 0.1 C, as-prepared sulfur-containing composite exhibited only one plateau, and delivered an initial discharge capacity of 1680 mAh/g and a reversible capacity of 1150 mAh/g calculated based on the mass of sulfur (sulfur utilization rate of 69%), as well as a cycle life of up to 100 cycles. When discharged at 5 C (discharge within 12 min), the reversible capacity still maintained 750 mAh/g (FIGS. 8-10).

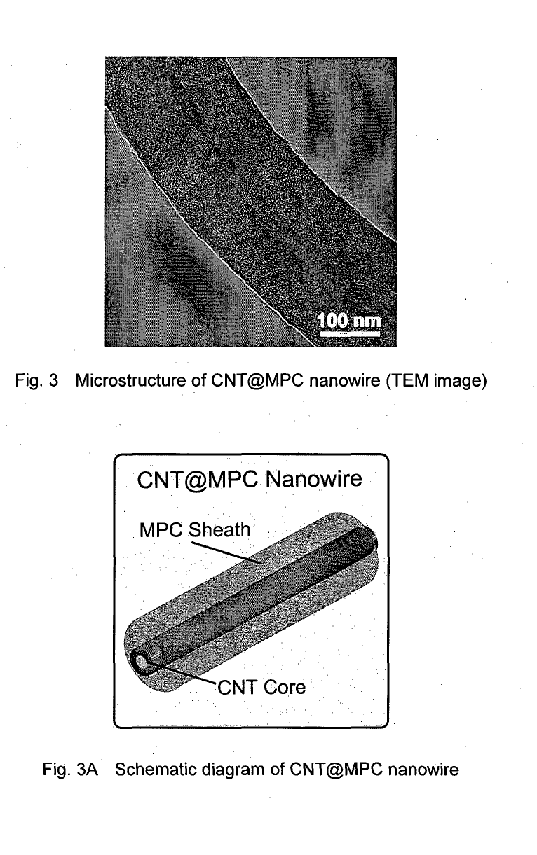

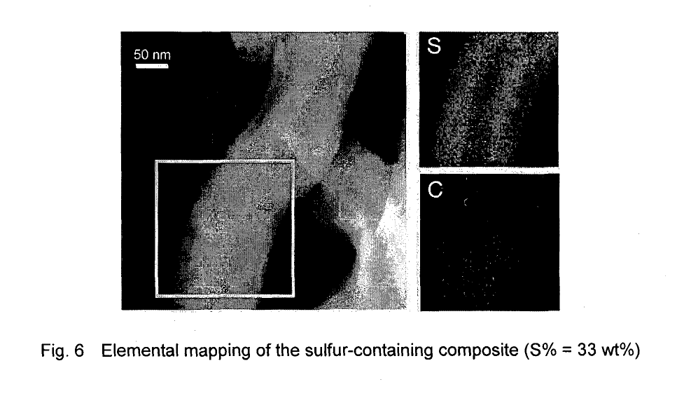

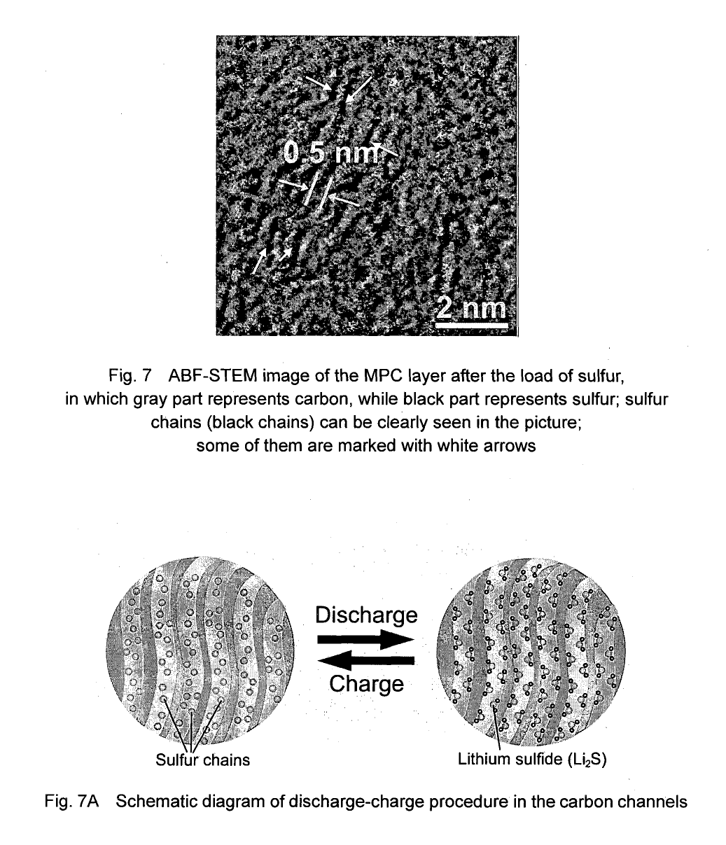

FIGS. 2 and 3 showed typical microstructures of the CNT@MPC composite prepared according to Example A, in which FIG. 3 clearly showed the coaxial cable-like structure of the CNT@MPC nanowire. FIG. 4 showed the structure of micropores on the CNT@MPC nanowire. FIGS. 5 and 6 respectively showed the microstructure and the elemental distribution of the sulfur-containing composite prepared from said CNT@MPC composite according to Example A with a sulfur content of 33 wt %. FIG. 7 showed the confined sulfur chains in the carbon micropores. FIGS. 8-10 showed the discharge-charge curves and the cycling performances of said sulfur-containing composite prepared according to Example A with a sulfur content of 33 wt %.

### EXAMPLE B

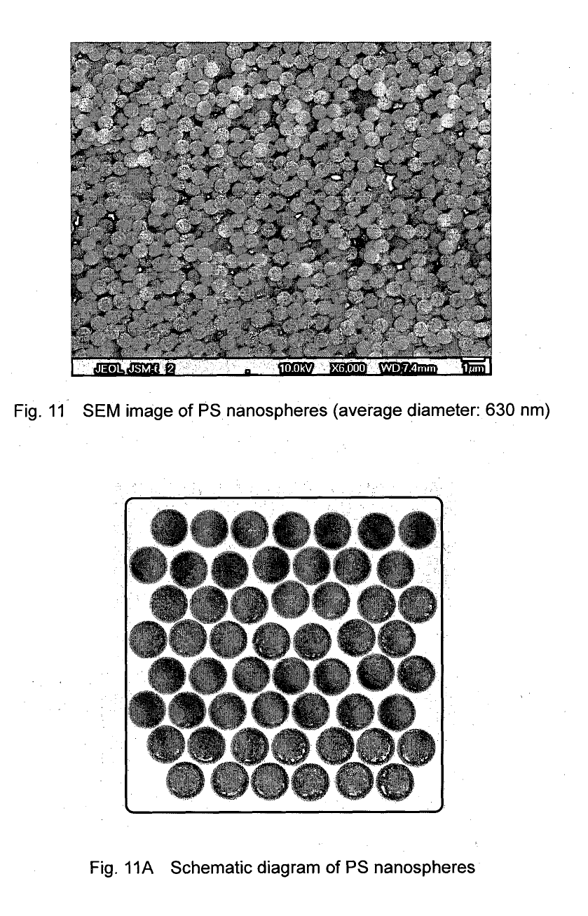

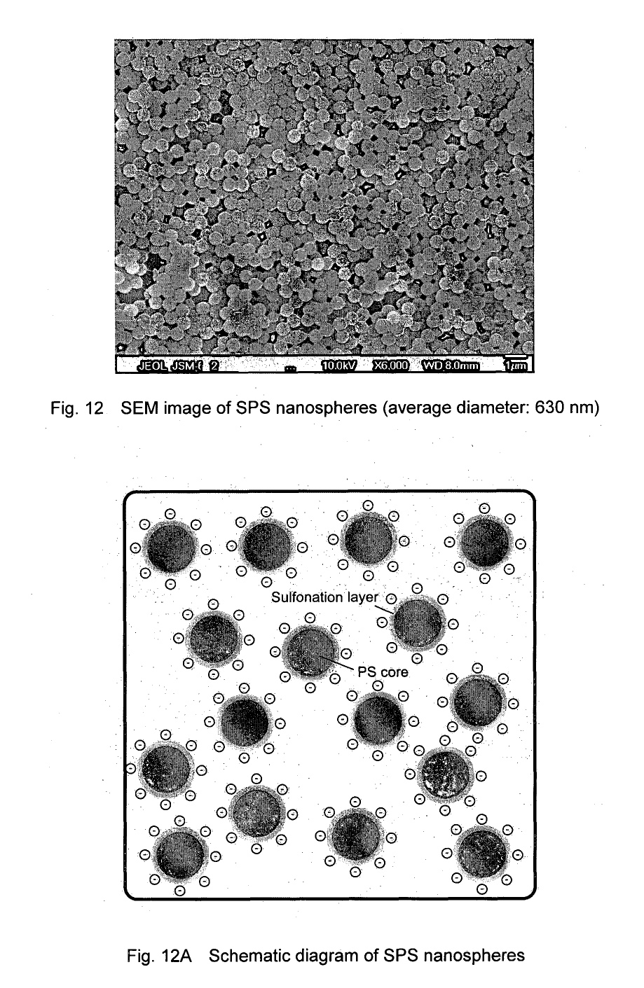

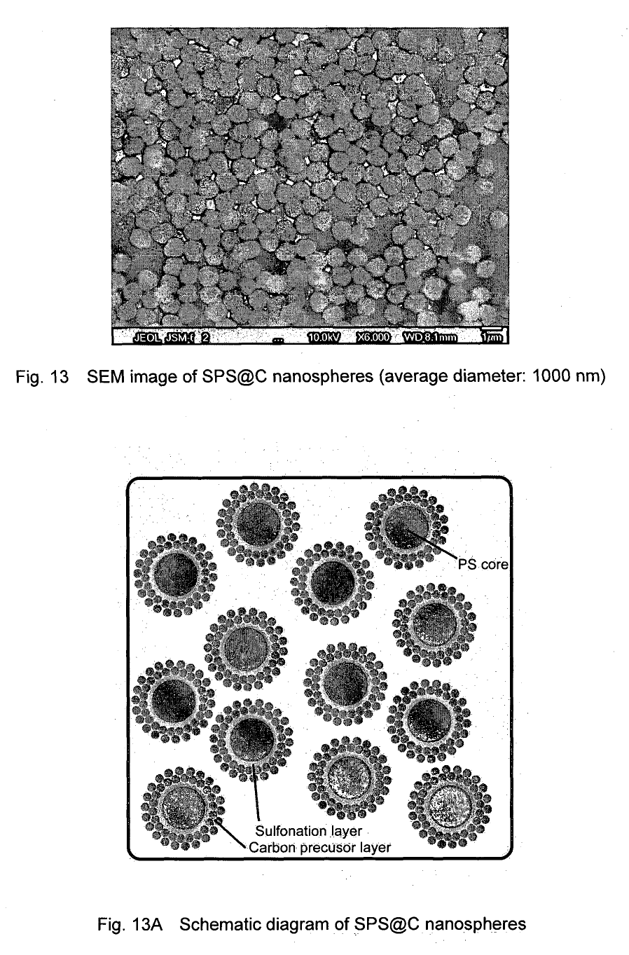

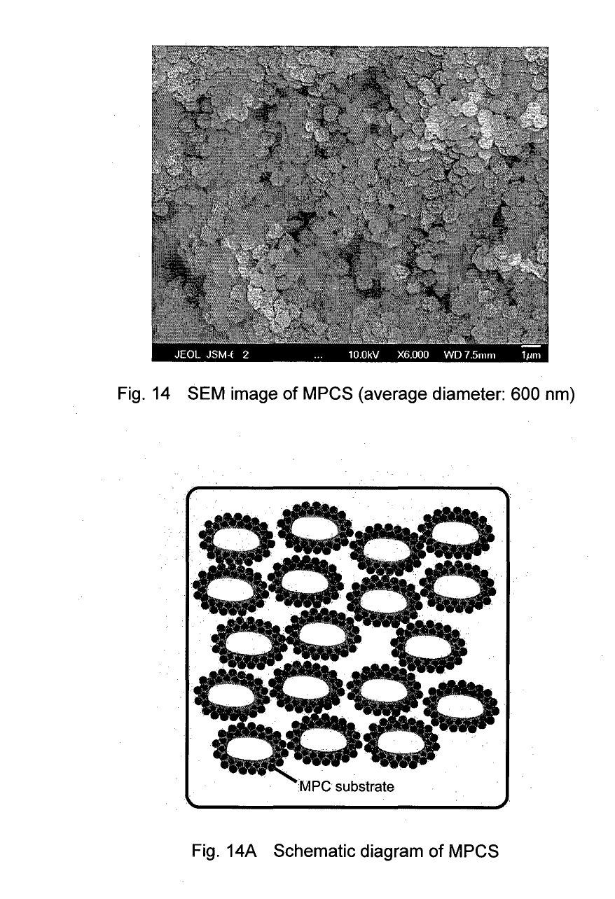

As the starting material, 40 g of styrene (Jinke Fine Chemical Institute, Tianjin, 99%) was added into 360 mL of water, and the mixture was degassed with nitrogen for 60 min before the addition of 0.15 g of ammonium persulfate ((NH₄)₂S₂O₈, AR grade, purchased from Sinopharm Chemical Reagent Co., Ltd.), and the reactants were incubated at 70° C. for 24 h to yield the polystyrene (PS) nanospheres with an average diameter of 630 nm (FIG. 11). After that, 1 g of as-obtained PS nanospheres were mixed with 20 g of concentrated sulfuric acid (MOS grade, purchased from Beijing Institute of Chemical Reagents, about 18.4 M), and incubated at 40° C. for 24 h to yield sulfonated-PS (SPS) nanospheres. After the removal of sulfuric acid, said SPS nanospheres were rinsed with water for several times and dried at 50° C. (FIG. 12). 800 mg of sucrose (AR grade, purchased from Sinopharm Chemical Reagent Co., Ltd.) were dissolved in 10 g of water, following by the addition of 300 mg of said SPS nanospheres and 2 mg of SDS (AR grade, Sinopharm Chemical Reagent Co., Ltd.) as the surfactant. Then the solution was sealed in an autoclave and heated at 180° C. for 10 h to yield the carbon coated SPS (SPS@C) nanospheres, in which a microporous carbon coating layer of 200 nm were formed on said SPS nanospheres. Said SPS@C nanospheres were washed with de-ionized water and dried in an oven at 50° C. overnight (FIG. 13). As-obtained SPS@C nanospheres were further annealed at 800° C. in nitrogen for 3 h with a heating rate of 5° C./min to vaporize the SPS inner core and further carbonize the carbon coating layer, and finally yield microporous carbon substrate (MPCS) with an average diameter of 600 nm (FIG. 14), a BET surface area of 653 m²/g, a pore volume of 1.42 cm³/g, and an average pore diameter of 0.71 nm.

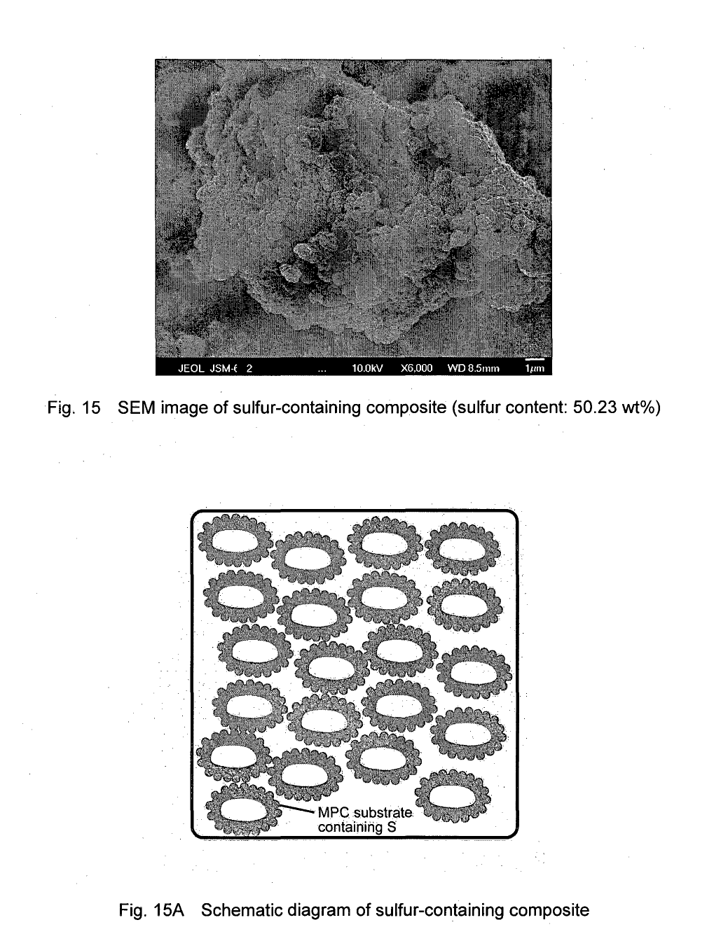

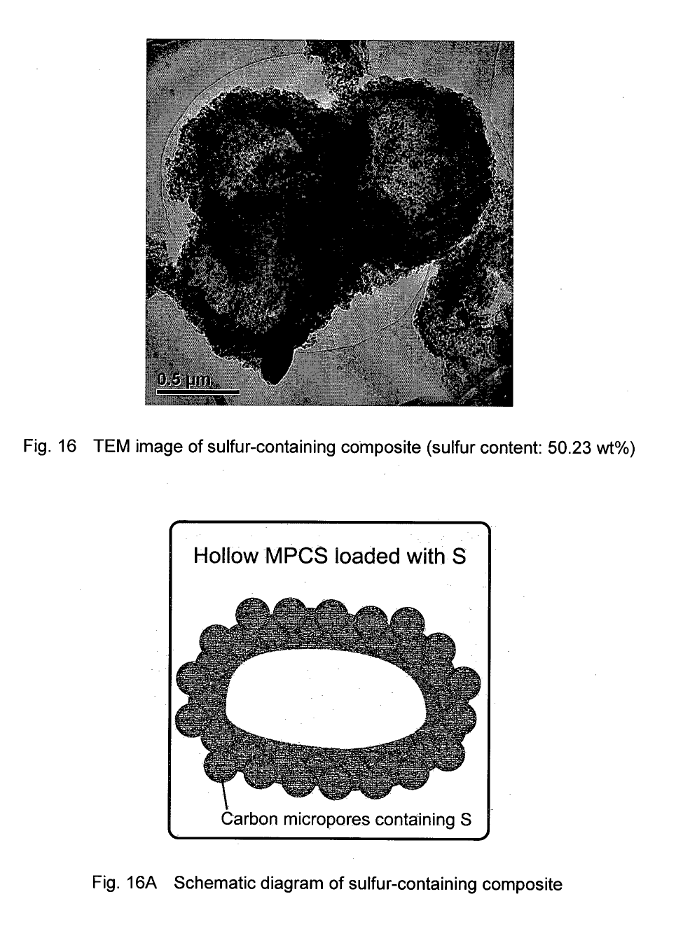

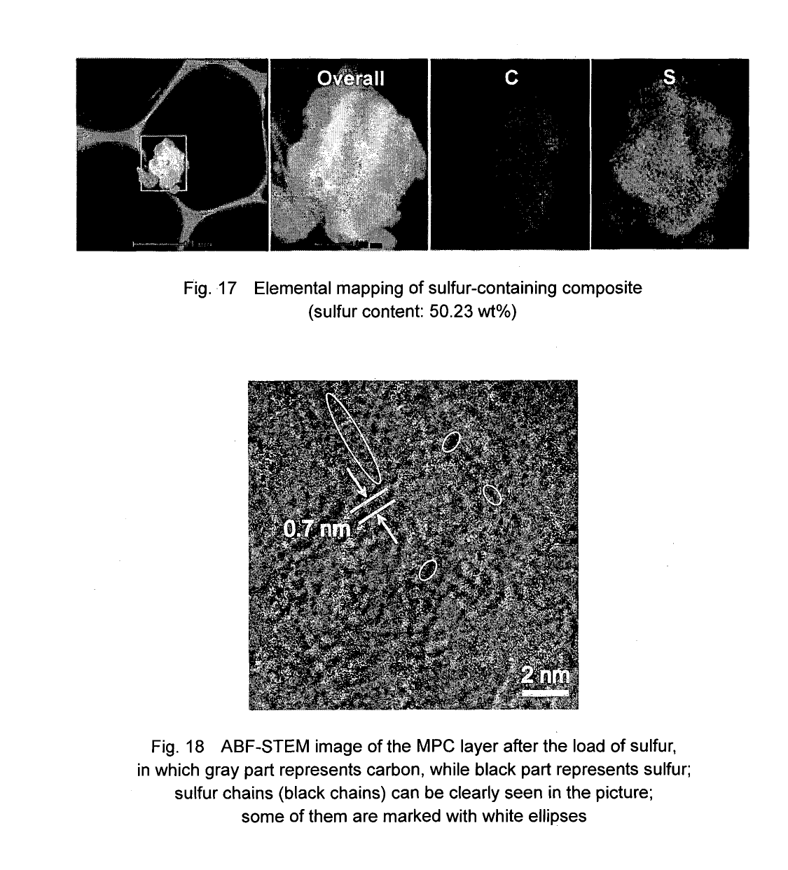

To prepare the sulfur-containing composite, sulfur powder (Aldrich, a purity of >99.995%) and the MPCS were mixed by a mass ratio of 1:1 to yield a homogeneous mixture, after that, the mixture was sealed in a glass container and heated at 155° C. for 20 h to make sulfur dispersed into the composite, and finally yielded the sulfur-containing composite with a sulfur content of 50.23% (FIGS. 15-18). After heating, the composite was naturally cooled down to room temperature to obtain the final product.

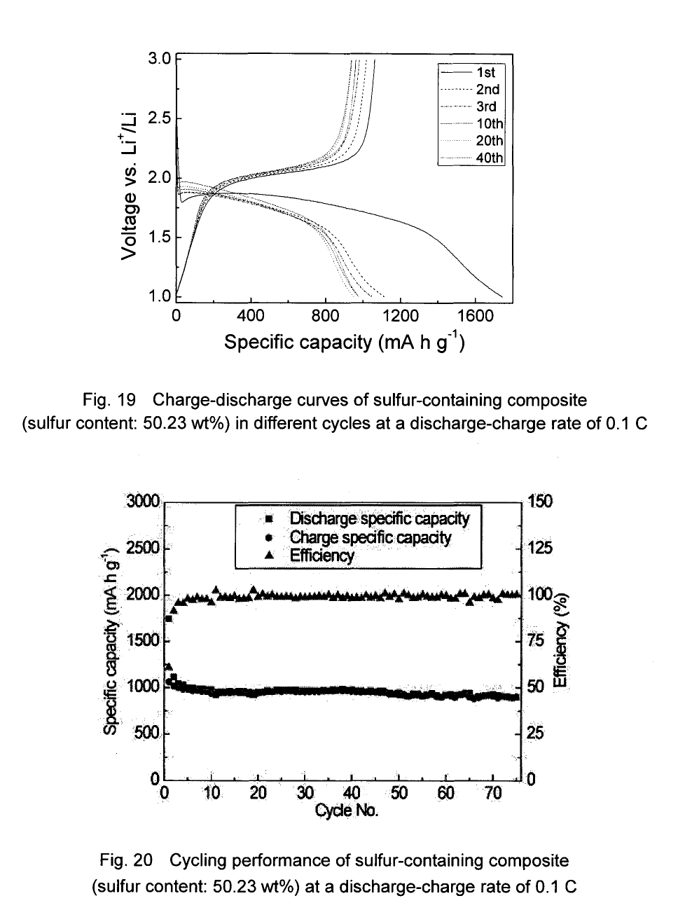

Electrochemical measurements were performed in the same way as Example A. When discharged at a rate of 0.1 C, said sulfur-containing composite demonstrated a first discharge capacity of 1720 mAh/g and reversible capacity of 1010 mAh/g calculated based on the mass of sulfur, utilization of active material higher than 60%, and a cycle life of up to 75 cycles (FIGS. 19 and 20).

The typical microstructures of PS nanospheres (average diameter: 630 nm), SPS nanospheres, SPS@C nanospheres (average diameter: 1000 nm), and MPCSs (average diameter: 600 nm) according to Example B were respectively shown in FIGS. 11-14. The microstructure and the elemental distribution of a sulfur-containing composite particle prepared from said microporous carbon substrate according to Example B with a sulfur content of 50.23 wt % were shown in FIGS. 15-17. FIG. 18 showed the details of sulfur distribution in the micropores. Charge-discharge curves of sulfur-containing composite (sulfur content: 50.23 wt %) in different cycles at a discharge-charge rate of 0.1 C were shown in FIG. 19, and cycling performance of said sulfur-containing composite (sulfur content: 50.23% wt %) was plotted in FIG. 20.

While certain embodiments have been described, these embodiments have been presented by way of example only, and are not intended to limit the scope of the inventions. The attached claims and their equivalents are intended to cover all the modifications, substitutions and changes as would fall within the scope and spirit of the invention.

1. A sulfur-containing composite, comprising a conductive microporous substrate and sulfur with chain structure loaded into said conductive microporous substrate.

2. The sulfur-containing composite of claim 1, wherein said conductive microporous substrate has a BET specific surface area of 300-4500 m²/g.

3. The sulfur-containing composite of claim 1, wherein said conductive microporous substrate has a pore volume of 0.1-3.0 cm³/g.

4. The sulfur-containing composite of claim 1, wherein said conductive microporous substrate has an average pore diameter of 0.2-1.0 nm.

5. The sulfur-containing composite of claim 1, wherein the diameter of said sulfur with chain structure is less than a pore diameter of said conductive microporous substrate.

6. The sulfur-containing composite of claim 1, wherein said sulfur-containing composite has a sulfur load amount of 20-85 wt, based on a total weight of said sulfur-containing composite.

7. The sulfur-containing composite of claim 1, wherein said conductive microporous substrate is selected from a group consisting of carbon-based substrates, non-carbon substrates, and combinations or composites of carbon-based substrates and non-carbon substrates.

8. The sulfur-containing composite of claim 7, wherein a non-carbon substrate is selected from a group consisting of microporous conductive polymers, microporous metal, microporous semiconductive ceramic, microporous coordination polymers, microporous metal-organic frameworks (MOFs), non-carbon molecular sieves and combinations, composites, and derivatives thereof.

9. The sulfur-containing composite of claim 7, wherein a carbon-based substrate is selected from the group consisting of carbon molecular sieve, carbon tube, microporous graphene, graphdiyne, amorphous carbon, hard carbon, soft carbon, graphitized carbon, and combinations, composites, derivatives and doped systems thereof

10. An electrode material, comprising the sulfur-containing composite of claim 1.

11. A lithium-sulfur battery, comprising the sulfur-containing composite of claim 1.

12. The sulfur-containing composite of claim 2, wherein said conductive microporous substrate has a pore volume of 0.1-3.0 cm³/g.

13. The sulfur-containing composite of claim 12, wherein said conductive microporous substrate has an average pore diameter of 0.2-1.0 nm.

14. The sulfur-containing composite of claim 13, wherein the diameter of said sulfur with chain structure is less than a pore diameter of said conductive microporous substrate.

15. The sulfur-containing composite of claim 14, wherein said sulfur-containing composite has a sulfur load amount of 20-85 wt %, based on a total weight of said sulfur-containing composite.

16. The sulfur-containing composite of claim 15, wherein said conductive microporous substrate is selected from a group consisting of carbon-based substrates, non-carbon substrates, and combinations or composites of carbon-based substrates and non-carbon substrates.

17. The sulfur-containing composite of claim 16, wherein a non-carbon substrate is selected from a group consisting of microporous conductive polymers, microporous metal, microporous semiconductive ceramic, microporous coordination polymers, microporous metal-organic frameworks (MOFs), non-carbon molecular sieves and combinations, composites, and derivatives thereof

18. The sulfur-containing composite of claim 16, wherein a carbon-based substrate is selected from the group consisting of carbon molecular sieve, carbon tube, microporous graphene, graphdiyne, amorphous carbon, hard carbon, soft carbon, graphitized carbon, and combinations, composites, derivatives and doped systems thereof.
